(19) United States
(12) Patent Application Publication
(10) Pub. No.: US 2011/0226253 A1
(43) Pub. Date: Sep. 22, 2011

(54) COUGH SHIELD

(75) Inventors: Amy M. Johnston, Grosse Pointe Woods, MI (US); David A. Johnston, Grosse Pointe Woods, MI (US)

(73) Assignee: EXCLUSIVE COMPUTER INNOVATIONS, LLC, Grosse Pointe Woods, MI (US)

(21) Appl. No.: 12/724,736

(22) Filed: Mar. 16, 2010

(51) Int. Cl. A62B 9/00; B23P 17/04

(52) U.S. Cl. 128/206.19; 29/428

(57) ABSTRACT

A cough shield includes a cough shield body expandable from a folded state to an open state and collapsible to return from the open to the folded state. The cough shield body is retained in an unbiased condition in the folded state until acted on by a user to open the cough shield body. An engagement member adhesively fixed to the body is accessible to the user in the folded state. The engagement member defines a cavity between the engagement member outer wall and an outer surface portion of the body. The engagement member slidably receives a user's finger to assist in opening or closing the cough shield body and to temporarily retain the cough shield in the open state in contact with the face of the user to at least partially cover the user's nose and mouth.

### FIELD

The present disclosure relates to hand held devices used to minimize airborne discharge during coughing or sneezing events.

### BACKGROUND

This section provides background information related to the present disclosure which is not necessarily prior art.

Devices such as surgical masks are known to act as disposable barriers affixed to an individual's head and particularly to the face area which minimize or prevent the transfer of contagions in a variety of settings including during surgery, air travel, in commuter transportation centers, and the like. Similarly, tissue or disposable handkerchiefs are commonly known, and are temporarily held in contact with the individual's face to capture mouth and nose discharge. Tissues are predominantly single-use items, and due to their flexibility do not conform well to the user's face to prevent transfer of contagions. Disposable handkerchiefs, although re-usable, also do not conform well to the user's face to prevent transfer of contagions.

### SUMMARY

This section provides a general summary of the disclosure, and is not a comprehensive disclosure of its full scope or all of its features.

A cough shield of the present disclosure is an object or apparatus of any material, fabric or tissue of any color, including patterns or textures, which is of sufficient strength to remain in an open state and retract to a smaller, compact folded state at the user's election. It can include a layer of absorptive fabric that does not impede the collapsibility of the device. An interior material, fabric or tissue may be treated with hypoallergenic and/or anti-bacterial, anti-viral solutions. A shape of the device when opened may vary with respect to overall appearance and can be, for example and not intended to be limiting, circular, square, diamond or concave shaped. The cough shield acts to shield against the passage of contagions in the form of airborne mouth or nasal discharge to the surrounding area or atmosphere. A size of the cough shield can vary dependent on the intended user, for example a child or an adult. To releasably retain the cough shield in contact with a hand of the user in lieu of releasably supporting the shield to the head or face of the user, an exterior mounted retention device in an exemplary form of a partial loop or ring can be affixed to the cough shield device to provide stable support in the hand of the user.

According to other embodiments a cough shield includes a cough shield body expanded from a folded state to an open state and collapsible to return from the open state to the folded state. The cough shield body is retained in an unbiased condition in the folded state until acted on by a user to open the cough shield body. An engagement member is fixed to the cough shield body and accessible to the user in the folded state. The engagement member defines a cavity between an outer wall of the engagement member and an outer surface portion of the cough shield body. The engagement member slidably receives one of the fingers of a user of the cough shield to assist in opening or closing the cough shield body.

According to further embodiments, the engagement member slidably receives one of the fingers of a user of the cough shield to assist in opening or closing the cough shield body and to temporarily retain the cough shield in the open state in contact with the face of the user to at least partially cover the nose and mouth of the user.

According to still further embodiments, a method for manufacturing a cough shield is provided. The cough shield includes an engagement member and a cough shield body having an outer surface portion. The method includes folding an initially flat material of a cough shield body at multiple fold lines to create a folded condition of the cough shield body; connecting the engagement member to the cough shield body; and creating a cavity between an outer wall of the engagement member and the outer surface portion of the cough shield body during the connecting step sized to permit a finger of a user to be inserted into the cavity.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front left perspective view of a cough shield of the present disclosure in an open state shown in contact/use on a user's face;

FIG. 2 is a bottom plan view of a flattened rectangular-shaped cough shield of the present disclosure prior to folding;

FIG. 3 is a plan view of the cough shield of FIG. 1, following a first folding step;

FIG. 4 is a plan view of the cough shield of FIG. 3, showing folding requirements for a second folding step;

FIG. 5 is a plan view of the cough shield following the second folding step;

FIG. 6 is a plan view of the cough shield of FIG. 5, showing folding requirements for a third folding step;

FIG. 7 is a front plan view of a fully folded cough shield following the third folding step;

FIG. 7A is a side elevational view of the fully folded cough shield after the third folding step of FIG. 7;

FIG. 8 is a front elevational view of the fully folded cough shield after the third folding step of FIG. 7;

FIG. 9 is a rear plan view of the cough shield of FIG. 7;

FIG. 10 is a rear elevational view looking forward of an open cough shield;

FIG. 11 is a rear elevational view of the open cough shield of FIG. 10 further showing a releasably attached absorption element positioned in an interior space of the open cough shield;

FIG. 12 is a front plan view modified from the cough shield of FIG. 7 having an engagement member attached;

FIG. 13 is a bottom plan view of a flattened rectangular-shaped cough shield having a first edge pattern, prior to folding;

FIG. 14 is a bottom plan view of a flattened rectangular-shaped cough shield having a second edge pattern, prior to folding; and

FIG. 15 is a bottom plan view of a flattened circular-shaped cough shield, prior to folding.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

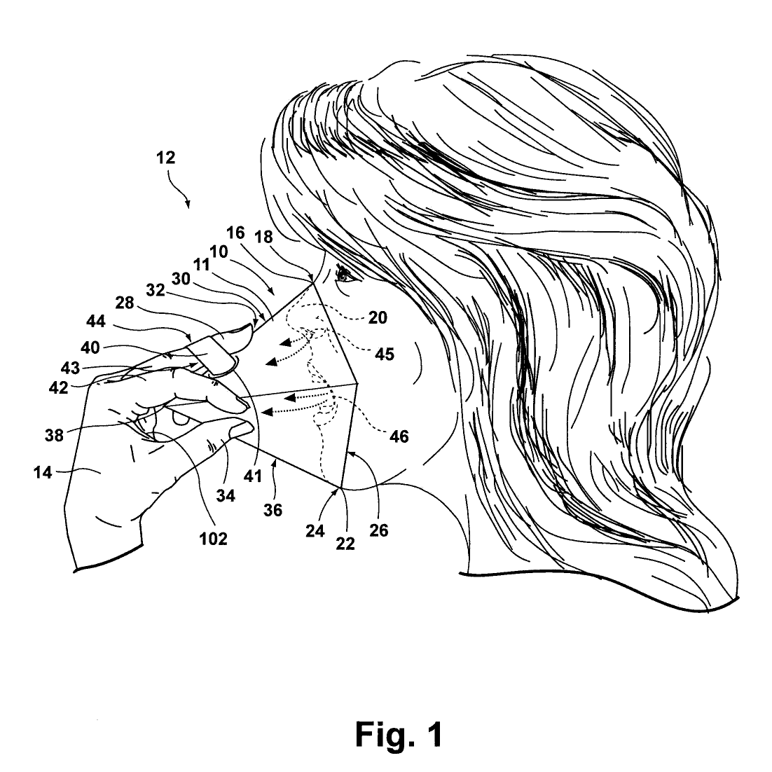

Referring to FIG. 1, a cough shield 10 of the present disclosure is shown in a fully extended or open position which permits a user to temporarily hold a cough shield body 11 in contact with a user's face 12. Cough shield 10 is not attached to the user's face or head, but is temporarily and releasably held in a hand 14 of the user. In the open state, a first contact portion 16 of cough shield body 11 is brought into physical contact with an area of the face 12, such as a bridge 18 of the nose 20. At the same time, a second contact portion 22 is brought and held into contact with a chin 24 area of the user's face 12. When contacting the bridge 18 of the nose 20 and the chin 24, at least a portion of a facial contact edge 26 contacts the face 12 on opposite sides of nose 20.

Cough shield 10 can be temporarily held in contact with the user's face 12 by pressure from a finger 28 such as the middle or ring finger of the user applied at a first outer surface portion 30 at a first contact area 32 of cough shield body 11. Cough shield body 11 can also be further aligned for contact with the user's face 12 by contact between a thumb 34 and a second outer surface portion 36 of cough shield body 11. When positioned as shown in FIG. 1, a distal end 38 of cough shield body 11 has an engagement member 40 connected, for example, using an adhesive 41 proximate to distal end 38. Engagement member 40 can be created in a semispherical loop or obround form having opposite ends connected to cough shield body 11, such that a finger 42, such as the index finger, or a middle or ring finger 28, or thumb 34 of the user, can be inserted into a cavity 43 created between first outer surface portion 30 of cough shield body 11 and an outer wall 44 of engagement member 40.

According to several embodiments, engagement member 40 can be created from a cloth, a polymeric, or a combination of cloth and polymeric materials which provide sufficient strength to permit the user to open and close cough shield 10 and further to temporarily hold cough shield 10 in contact with the user's face 12 by use of engagement member 40 alone if desired. According to additional embodiments, engagement member 40 can include or be created from an elastically deflectable material, such that insertion of finger 42 or 28 into cavity 43 stretches the material of engagement member 40, providing a biasing force to retain finger 42 or 28 within cavity 43 and in contact with first outer surface portion 30, such that the biasing force helps retain contact with cough shield body 11 to provide sole support of cough shield body 11 by the user.

When cough shield 10 is in the fully open state (as shown in FIG. 1), nasal openings 45 of the nose 20 as well as a mouth 46 of the user are substantially covered by cough shield body 11, such that fluid, mucus, or the like are trapped within cough shield body 11 for example during expectoration, exhalation, or sneezing by the user. Expectorant is therefore trapped within cough shield body 11 and prevented from passing through the material layers or layer of cough shield body 11 to the area surrounding the user or to the general atmosphere.

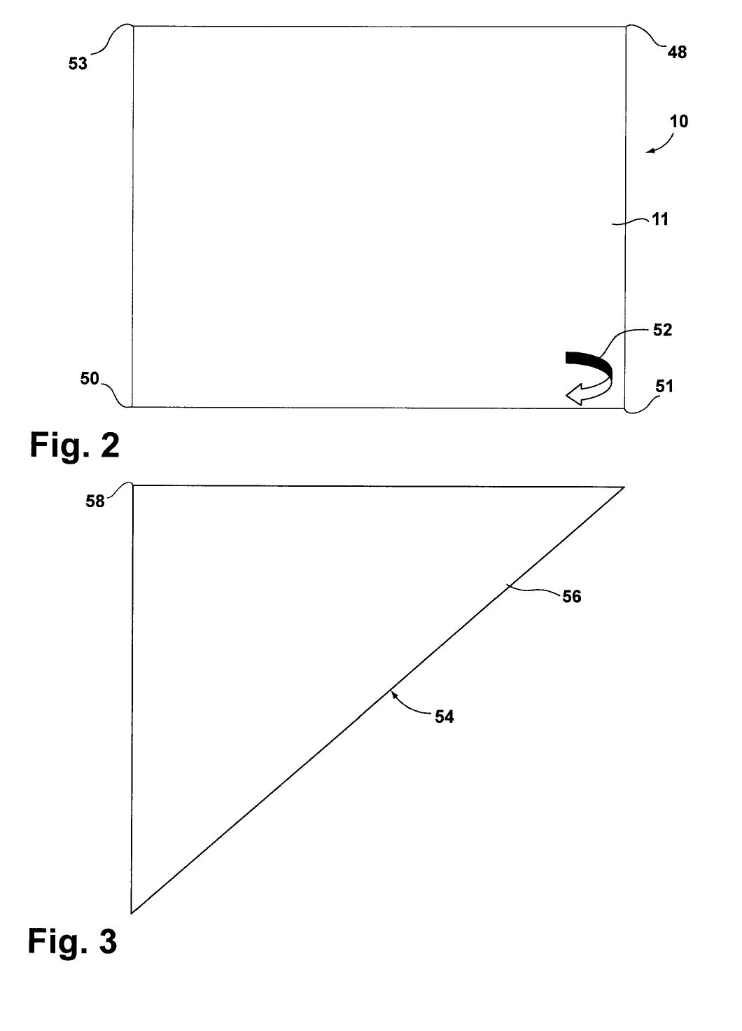

Referring to FIG. 2, according to several embodiments, cough shield body 11 of cough shield 10 can be initially created from a geometrically-shaped such as a rectangular-shaped piece of material and thereafter folded into a smaller configuration adapted for holding in the hand of the user. From a substantially flat configuration of the material of cough shield body 11, a first corner 48 and an angularly opposite positioned second corner 50 define locations about which cough shield body 11 can be folded in a first folding step. In the first folding step, a third corner 51 is folded upwardly (toward the viewer as viewed in FIG. 2) in a first fold direction 52 to contact or overlap an angularly opposite positioned fourth corner 53.

Referring to FIG. 3, after the first fold described in reference to FIG. 2 is completed, third corner 51 substantially contacts or overlaps fourth corner 53, defining a first folded body configuration 56 having a generally triangular shape, and a first fold line 54. With third corner 51 contacting or overlapping fourth corner 53, a first overlap corner 58 is created.

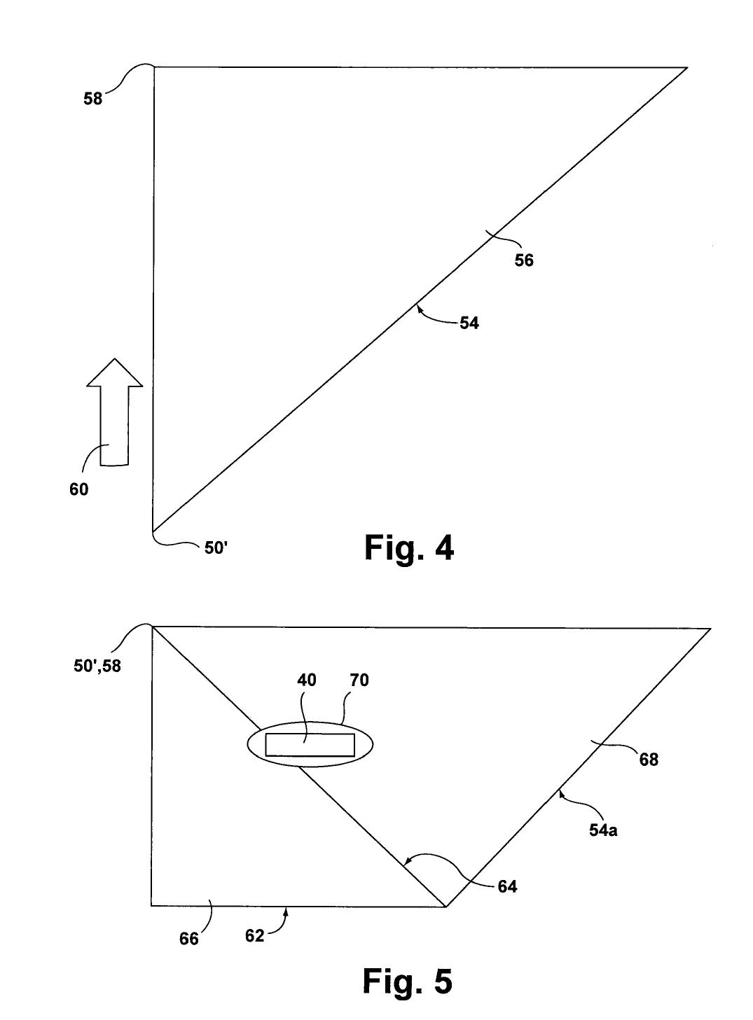

Referring to FIG. 4 and again to FIG. 2, following the first fold step described above, in a second fold step second corner 50′ is folded in a second fold direction 60 toward first overlap corner 58. Second fold direction 60 is different from first fold direction 52, and in the present embodiment is substantially transverse to first fold direction 52.

Referring to FIG. 5, following the second fold step, second corner 50′ and first overlap corner 58 are brought together or overlapped defining a second fold line 62 and a second fold body edge 64. Also following the second fold step a second folded body configuration 66 and an extending body portion 68 are created. A remaining portion of first fold line 54 is shown as first fold line 54a. At this time, the engagement member 40 is connected (for example by sewing or adhesive bonding) at an attachment zone 70 of extending body portion 68. An exact position placement of engagement member 40 on extending body portion 68 is not required and can be varied from the position of attachment zone 70 shown.

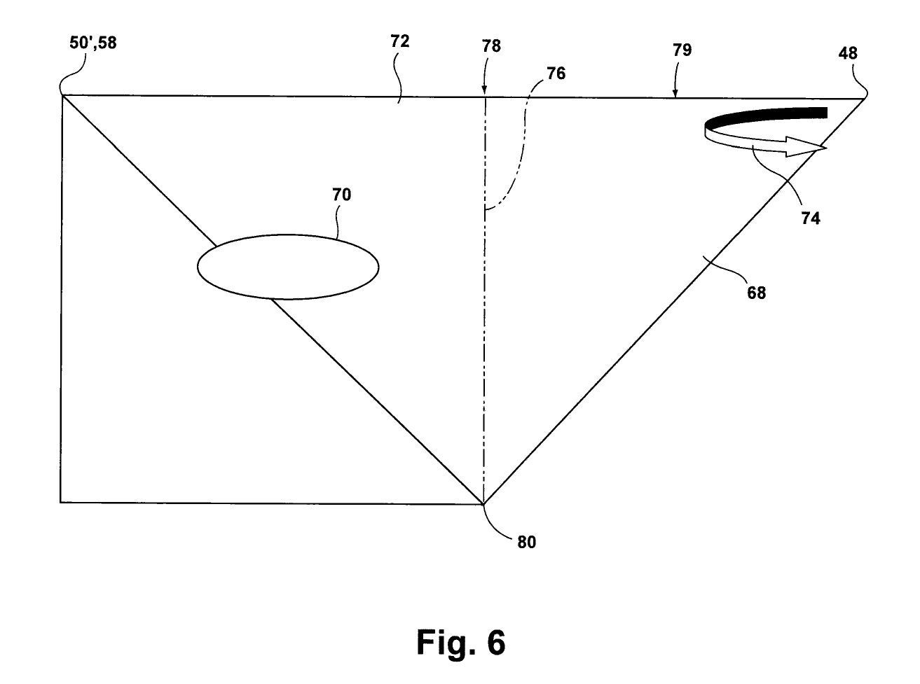

Referring to FIG. 6 and again to FIGS. 2 and 4, following the second fold step, extending body portion 68 can be subsequently folded in a third fold step, which will define a triangular-shaped body portion 72, by grasping first corner 48 and folding extending body portion 68 in a third fold direction 74 (away from the viewer as viewed in FIG. 6) about a third fold line 76. Third fold line 76 is defined between a fold point 78 which is oriented substantially transverse to a body edge 79, and a third fold corner 80. The third fold direction 74 is oriented differently that either second fold direction 60 or first fold direction 52, and in the present embodiment is substantially transverse to second fold direction 60 and connects to the opposite first overlap corner 58.

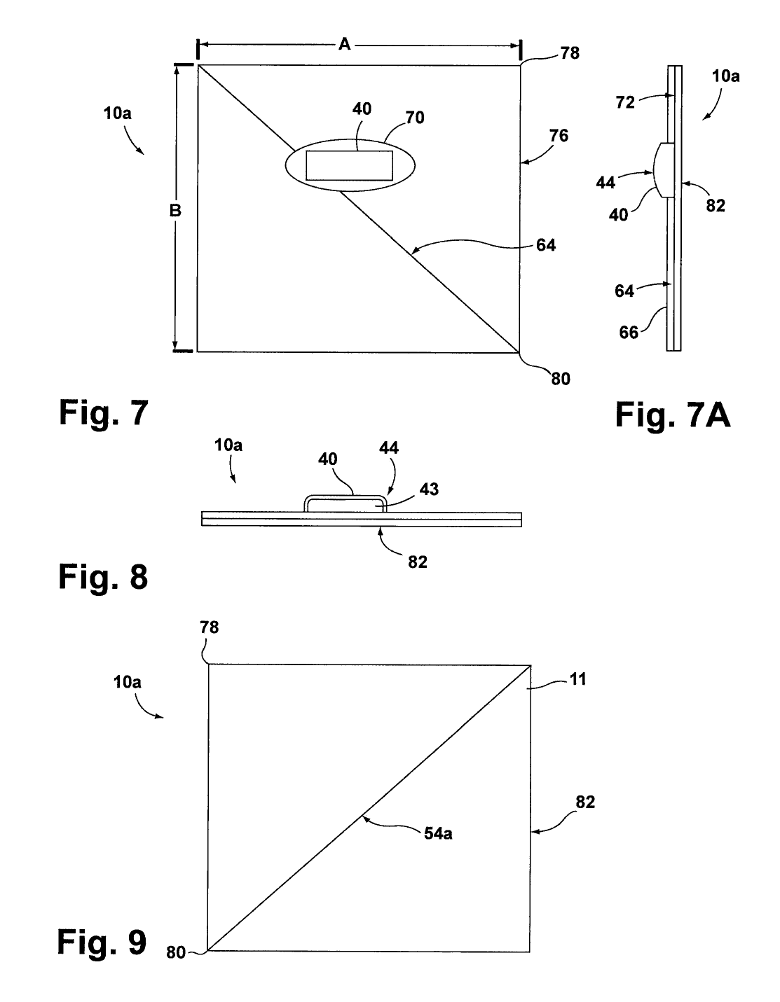

Referring to FIG. 7, a completely folded configuration of cough shield 10 (shown as cough shield 10a) is created after the third fold step described in reference to FIG. 6, such that third fold line 76 creates an outer facing surface of cough shield 10a. The various folding steps to create cough shield 10a are predetermined, such that a width “A” and a height “B” of cough shield 10a are sized to permit retention within a palm area of the user's hand, where cough shield 10a can be substantially hidden from view when the user's fingers are closed over cough shield 10a, and therefore predominantly out of sight of any other person in the area of the user. This permits the user to hold cough shield 10a indefinitely, for example during travel such as by airplane, train, taxi, or the like, where the user may prefer that cough shield 10a be out of sight.

Referring to FIG. 7A, engagement member 40 is shown in an installed position extending oppositely with respect to a front facing side 82 of folded cough shield 10a. Engagement member 40 can be fixed to triangular-shaped body portion 72, and alternately can be fixed at opposite ends to each of triangular-shaped body portion 72 and to second folded body configuration 66.

Referring to FIG. 8, in the fully folded condition of cough shield 10a cavity 43 of engagement member 40 is available for insertion of one of the fingers of the user. The user can therefore retain cough shield 10a in the fully folded state while maintaining engagement with engagement member 40. This permits releasable retention of cough shield 10a in the hand of the user.

Referring to FIG. 9 and again to FIG. 8, the remaining portion of first fold line 54a is visible from the front facing side 82 of cough shield body 11 when cough shield 10a is in the folded condition. Contact of one of the user's fingers with first fold line 54a while also at the same time either pulling engagement member 40 (extending as shown in FIG. 8) or opening the area between the materials at front facing side 82 will open cough shield 10. The material of cough shield 10 permits un-biased retention in the fully folded condition until the user elects to manually open cough shield body 11. Cough shield 10 will therefore not spring open when in the folded condition.

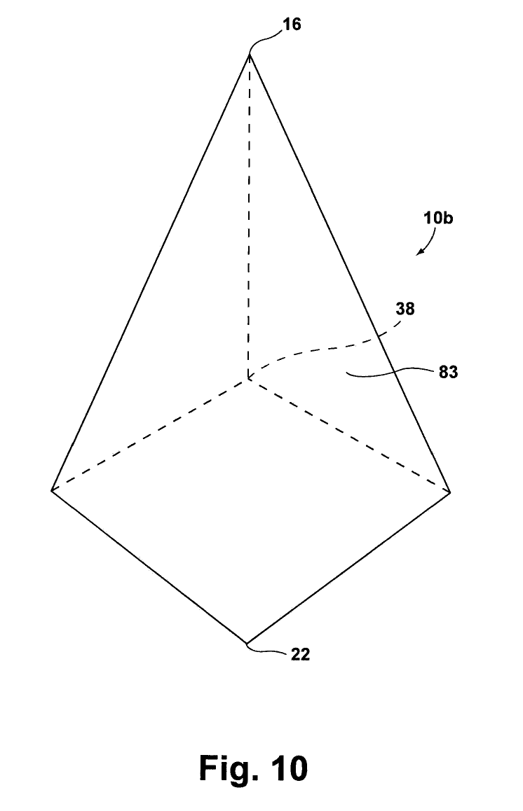

Referring to FIG. 10 and again to FIG. 1, the open or fully extended condition of cough shield 10 is presented, designated as cough shield 10b. In the open condition, an inner cavity 83 is created which receives at least a portion of the user's nose and at least partially covers the user's mouth when held in the orientation shown with respect to FIG. 1. The embodiment shown in FIG. 10 corresponds approximately to a diamond-shaped open configuration, however this shape is not limiting to the disclosure herein. Oval, rectangular, circular and other shapes can also be created in the open condition.

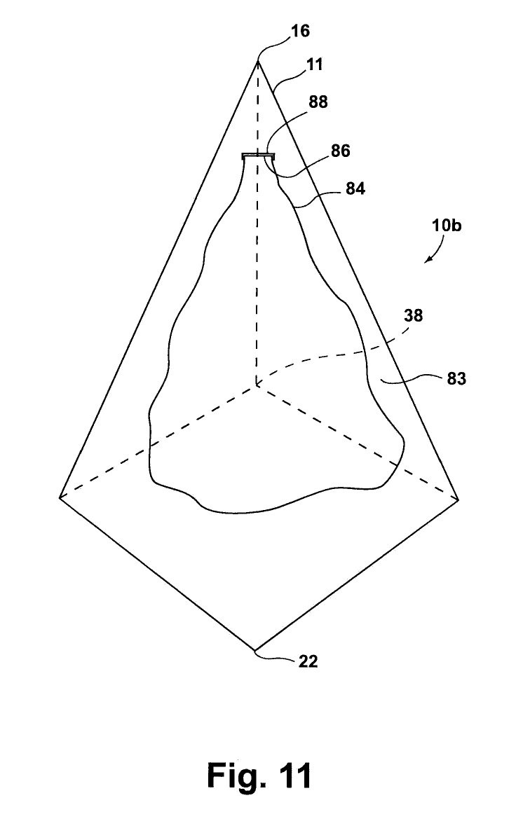

Referring to FIG. 11, with the cough shield 10b in the fully open position, access to an absorption element 84 is provided for either installation or removal of the absorption element 84. The absorption element 84 can be a cloth or tissue material which is adapted to absorb liquids such as fluids expelled by the user of cough shield 10b. According to several embodiments, absorption element 84 can include a tab 86 which is inserted through a slot/opening 88 created in the outer wall of cough shield body 11. Tab 86 can be bent or deformed once inserted through slot/opening 88 to temporarily retain absorption element 84 within inner cavity 83. According to several embodiments, absorption element 84 can be selected from a material which can be, together with cough shield 10, refolded to the collapsed or fully folded position and reopened multiple times at the discretion of the user, without being hindered by the presence of absorption element 84.

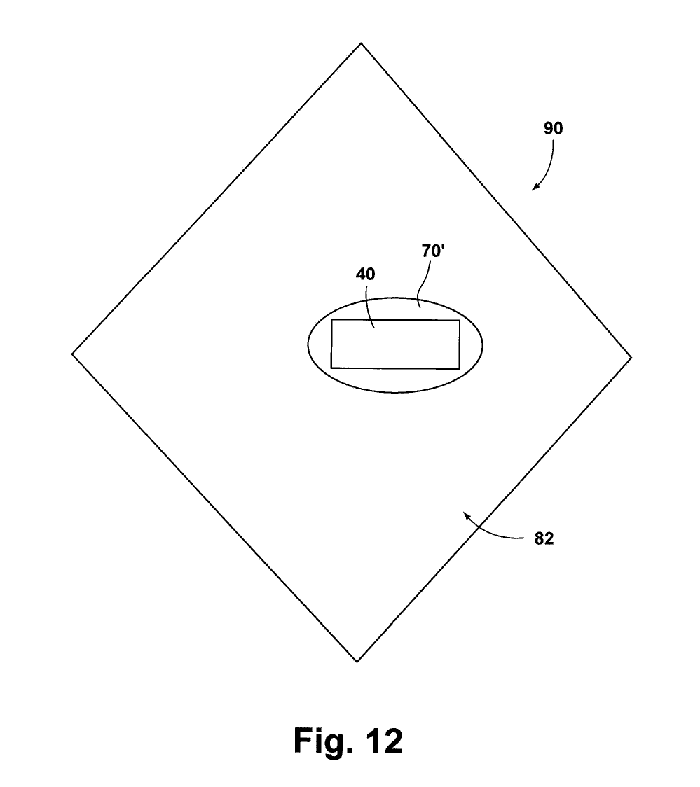

Referring to FIG. 12, according to additional embodiments, engagement member 40 can be connected to an attachment zone 70′ on the front facing side 82, defining a cough shield 90. Cough shield 90 is otherwise formed by folding, using the same or similar folding steps as previously described herein.

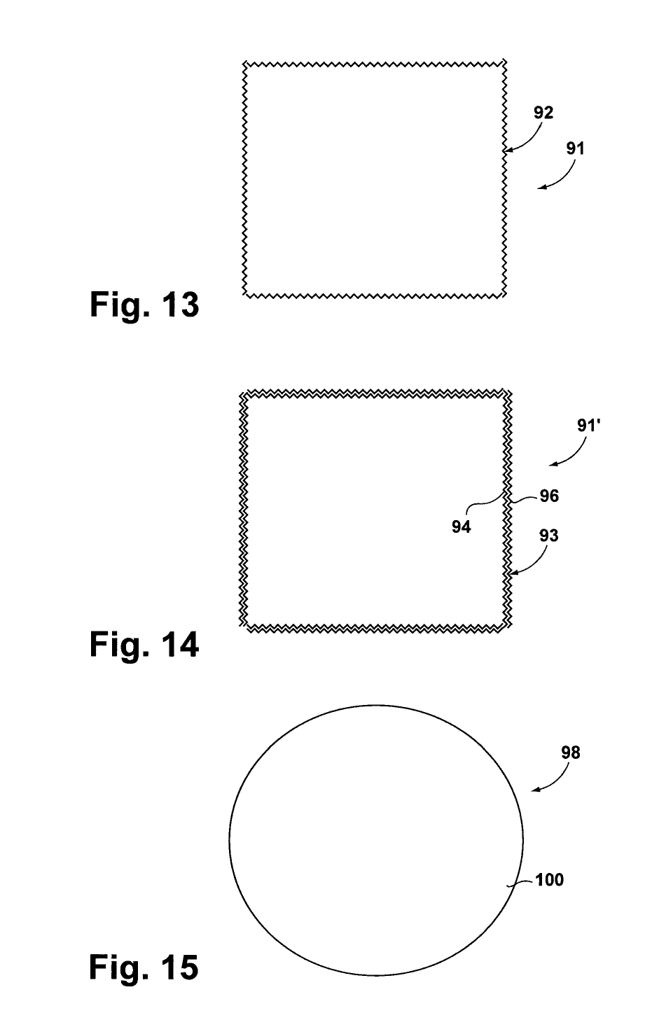

Referring to FIG. 13 and again to FIG. 1, a cough shield 91 can include a first edge pattern 92. First edge pattern 92, as shown, defines multiple raised portions which help the user to grasp and open cough shield 91. First edge pattern 92 can be created during the manufacturing process by a tool used to create the outer edges of the cough shield body. The engagement member 40 (shown and described with reference to FIG. 1) can also be included with cough shield 91.

Referring to FIG. 14 and again to FIG. 1, a cough shield 91′ is modified from the embodiment shown in FIG. 13 to include a second edge pattern 93 which includes each of an inner edge 94 and an outer edge 96. Inner edge 94 and outer edge 96 can be complimentary or oppositely facing with respect to each other. The engagement member 40 (shown and described with reference to FIG. 1) can also be included with cough shield 91′.

Referring to FIG. 15 and again to FIG. 1, a cough shield 98 is shown, having a circular-shaped body 100 providing an additional optional configuration for cough shields of the present disclosure. Circular-shaped body 100 can also be folded in similar steps to those previously described herein. The engagement member 40 (shown and described with reference to FIG. 1) can also be included with circular-shaped body 100 of cough shield 98.

Referring again to FIG. 1, a palm area 102 of the user is shown for reference. Palm area 102, as previously described herein, can be used to conceal a fully folded cough shield of the present disclosure while the user continues to releasably retain the cough shield through use of engagement member 40. Engagement member 40 can be engaged with any of the fingers of the user and is not limited to use of the index finger shown. For example, the middle or ring finger of the user can be used, as well as the thumb for insertion of engagement member 40, at the option of the user.

According to several embodiments, and referring again to FIGS. 1 and 7-10, cough shield 10 includes a cough shield body 11 expanded from a folded state (shown in FIG. 7) to an open state (shown in FIG. 10) and collapsible to return from the open state to the folded state. The cough shield body 11 is retained in an unbiased condition in the folded state until acted on by a user to open the cough shield body. The unbiased condition occurs from an inelastic property of the material of cough shield body 11 which can include cloth, fabric, polymeric material, or a combination of these materials which does not automatically spring open from the folded or closed state. The material at the various fold lines can, when creased, provide for repeatability of folding at the fold lines when re-opening or re-folding cough shield 10 to retain a consistent open state shape. The engagement member 40 can be directly fixed to the cough shield body 11 such as by sewing or indirectly fixed by adhesive 41 between engagement member 40 and cough shield body 11, and is accessible to the user in the folded state as evident in FIGS. 7 and 8. The engagement member 40 includes cavity 43 between the outer wall 44 of the engagement member and the outer surface portion 30 of the cough shield body 11. The engagement member 40, via the cavity 43 slidably receives one of the fingers 42, such as the index finger, or any one of the other fingers 28, or thumb 34 of the user of the cough shield 10 to assist in opening or closing the cough shield body 11.

According to several embodiments, and referring again to FIGS. 4, 5 and 6 the first fold line 54 in the cough shield body 11 is created during folding in a first fold direction 52. The second fold line 62 in the cough shield body 11 is created during folding in a second fold direction 60 different from the first fold direction 52. The third fold line 76 in the cough shield body 11 is created during folding in a third fold direction 74 different from both the first and second fold directions 52, 60.

FIG. 2 depicts the flattened view of cough shield 10 prior to folding. Formation of the cough shield 10 begins with material in a flattened state having a square, rectangular, or other geometric shape, and may be modified to create a circular, diamond or other geometrically shaped edge design, including those illustrated herein, but not limited to the shapes depicted in the Figures. FIGS. 3-6 represent exemplary folds used to create the cough shield, although the sequential process used for each fold, while providing one example, is not mandatory. For example, the third fold line 76 depicted in FIG. 6 may occur prior to the first fold line 54 depicted in FIGS. 3 and 4.

FIGS. 7 and 9 depict the cough shield 10 in the smaller, collapsed and folded form, which can be held substantially out of sight and indefinitely in the palm of the user's hand, and/or releasably affixed to a finger using engagement member 40 until opened for use. As indicated above, the size or space envelope (calculated by multiplying the width “A” by the height “B”) shown and described in reference to FIG. 7 can be varied dependent on the intended user (i.e. child or adult). For example only, the cough shield 10 intended for a child can have a width “A” of 2.5 cm (1 inch) and a height “B” of 2.5 cm (1 inch) such that the space envelope equals 6.25 cm² (1 in²), and the cough shield 10 intended for an adult can have a width “A” of 5.0 cm (2 inch) and a height “B” of 5.0 cm (2 inch) such that the space envelope equals 25.0 cm² (2 in²).

FIGS. 10 and 11 are representations of cough shield 10 shown in the open state during use. It is anticipated that in an exemplary application the user places cough shield 10 in the open state substantially over the nose and mouth during a cough, sneeze or any other event that could result in expelling air or other expectorant discharge. The inner cavity 83 traps all or substantially all of the discharge from the nose and/or mouth. FIG. 12 provides another embodiment having the engagement member 40 located on front facing side 82 which will contact the palm 102 of a cough shield 90 when in the open state. The cough shield 90 may fold open and/or closed using fold lines in different sequential order from those described in reference to FIGS. 2-7.

Cough shields of the present disclosure are disposable, collapsible personal hand-held devices that, when opened, can be used for capturing and/or preventing passage and spread of airborne mouth and/or nasal discharge expelled during a cough, sneeze or other event. When collapsed to a folded condition the device can remain in the smaller, folded state while not in use. Cough shields of the present disclosure are further directed to mitigating the spread of germs, excretions and disease. Cough shields of the present disclosure are an improvement to the common facial tissue in that they are stronger, more durable and have the ability to open and close for repetitive uses, while also being capable of remaining in a disposable form for replacement by a fresh cough shield at the user's option. Cough shields 10 can also include a thinner layer of absorptive material or fabric that does not impede the collapsibility of the device. The absorptive material, fabric or tissue can be treated with hypoallergenic, anti-bacterial, and/or anti-viral solutions. Cough shields of the present disclosure do not include an attachment feature used to releasably attach the cough shield to the user's head or face, commonly known with surgical masks, but instead provide engagement member 40 allowing releasable retention by the hand/fingers of the user, and further to help hold the cough shield only in temporary contact with the user's face.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A cough shield, comprising:
a cough shield body expanded from a folded state to an open state and collapsible to return from the open state to the folded state; and
an engagement member fixed to the cough shield body and accessible to a user in the folded state, the engagement member defining a cavity between an outer wall of the engagement member and an outer surface portion of the cough shield body, the engagement member configured to slidably receive one of the fingers of a user of the cough shield to assist in opening or closing the cough shield body.

2. The cough shield of claim 1, wherein the cough shield body includes a plurality of fold lines permitting repeatable collapse from the open state to the folded state having a repeatable folded state space envelope.

3. The cough shield of claim 2, wherein when the cough shield body is releasably retained in a palm of the user in the folded state by engagement of the user's finger in the engagement member cavity, the space envelope of the cough shield body in the folded state is substantially covered from view when the fingers are folded over the palm and cough shield body.

4. The cough shield of claim 1, wherein in the open state the cough shield body includes a facial contact edge contacting at least a portion of the face of the user including the nose and the mouth.

5. The cough shield of claim 4, wherein in the open state the cough shield body facial contact edge defines a diamond or concave shape.

6. The cough shield of claim 1, further including:
an inner cavity of the cough shield body created in the open state; and
an absorption element releasably connected through a slot of the cough shield body and aligned with the user's nose and mouth in the inner cavity acting to absorb discharge from the nose and mouth, the absorption element releasable from the slot for replacement.

7. The cough shield of claim 1, wherein the cough shield body is retained in an unbiased condition in the folded state until acted on by the user to open the cough shield body.

8. A cough shield, comprising:
a cough shield body expandable from a folded state to an open state and collapsible to return from the open state to the folded state, the cough shield body retained in an unbiased condition in the folded state until acted on by a user to open the cough shield body; and
an engagement member adhesively fixed to the cough shield body and accessible to the user in the folded state, the engagement member defining a cavity between an outer wall of the engagement member and an outer surface portion of the cough shield body, the engagement member slidably receiving one of the fingers of a user of the cough shield to assist in opening or closing the cough shield body and to temporarily retain the cough shield in the open state in contact with the face of the user to at least partially cover the nose and mouth of the user.

9. The cough shield of claim 8, further including an absorption element releasably connected to the cough shield body and aligned with the user's nose and mouth when the cough shield in held in contact with the user's face acting to absorb discharge from the nose and mouth, the absorption element being releasable for replacement.

10. The cough shield of claim 9, wherein the absorption element is treated with at least one of a hypoallergenic, an anti-bacterial, and an anti-viral solution.

11. The cough shield of claim 8, further including a slot created in the cough shield body slidably receiving the absorption element to releasably connect the absorption element to the cough shield.

12. The cough shield of claim 8, further including at least three fold lines created to fold the cough shield body from the open state to the folded state.

13. The cough shield of claim 8, further including:
a first fold line in the cough shield body created during folding in a first direction;
a second fold line in the cough shield body created during folding in a second direction different from the first direction; and
a third fold line in the cough shield body created during folding in a third direction different from both the first and second directions.

14. The cough shield of claim 8, wherein the engagement member is elastically deflectable to bias the one of the fingers of the user into contact with the outer surface portion of the cough shield body.

15. A method for manufacturing a cough shield, the cough shield including an engagement member and a cough shield body having an outer surface portion, the method comprising:
folding an initially flat material of a cough shield body at multiple fold lines to create a folded condition of the cough shield body;
connecting the engagement member to the cough shield body; and
creating a cavity between an outer wall of the engagement member and the outer surface portion of the cough shield body during the connecting step sized to permit a finger of a user to be inserted into the cavity.

16. The method of claim 15, further comprising performing the connecting step of the engagement member by directly sewing the engagement member to the cough shield body.

17. The method of claim 15, further comprising performing the connecting step of the engagement member by interposing an adhesive between the engagement member and the cough shield body.

18. The method of claim 15, further comprising performing the folding step by creating a first folded body configuration at a first fold line in the cough shield body during folding in a first direction.

19. The method of claim 18, further comprising performing the folding step by creating a second folded body configuration by a second fold line in the cough shield body during folding in a second direction different from the first direction.

20. The method of claim 19, further comprising performing the folding step by folding at a third fold line to rotate an extending body portion about a triangular shaped body portion of the cough shield body in a third direction different from both the first and second directions.
